(19) United States
(12) Patent Application Publication
(10) Pub. No.: US 2021/0223779 A1
(43) Pub. Date: Jul. 22, 2021

(54) SYSTEMS AND METHODS FOR REROUTING ROBOTS TO AVOID NO-GO ZONES

(71) Applicant: Brain Corporation, San Diego, CA (US)

(72) Inventor: Jean-Baptiste Passot, San Diego, CA (US)

(21) Appl. No.: 17/205,692

(22) Filed: Mar. 18, 2021

Related U.S. Application Data
(63) Continuation of application No. PCT/US19/51835, filed on Sep. 19, 2019.
(60) Provisional application No. 62/733,274, filed on Sep. 19, 2018.

(51) Int. Cl. G05D 1/02; G01C 21/20

(52) U.S. Cl. CPC G05D 1/0214; G05D 2201/0203; G01C 21/20; G05D 1/0274

(57) ABSTRACT

Systems and methods for global rerouting of a path of a robot are disclosed herein. According to at least one non-limiting exemplary embodiment, a robot may reroute a path based on one or more rerouting zones, wherein the rerouting zone comprises an area undesirable for the robot to navigate. Accordingly, the present disclosure provides systems and methods for a robot to reroute a path based on the rerouting zones.

### PRIORITY

This application is a continuation of International Patent Application No. PCT/US19/51835 filed Sep. 19, 2019 and claims the benefit of U.S. Provisional Patent Application Ser. No. 62/733,274 filed on Sep. 19, 2018 under 35 U.S.C. § 119, the entire disclosure of each are incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for rerouting of a robot.

### Background

Robots may be programmed to perform tasks autonomously. Some contemporary robots may follow a set of instructions in performing a robotic task.

In some cases, contemporary robots may be configured to navigate an environment. These robots may, in some cases, move in a particular sequence in an area. For example, a robot may follow a path through an environment while making small deviations from the path to avoid obstacles and other inhibitions to the travel of the robot.

However, in some cases, there may be obstacles and/or inhibitions that greatly hinder a conventional robot's ability to travel. These obstacles and/or inhibitions may cause a robot to become stuck and/or fail in navigating an environment. Accordingly, there is a need in the art for improved systems and methods for rerouting a robot.

### SUMMARY

The foregoing needs are satisfied by the present disclosure, which provides for, inter alia, systems and methods for robotic path planning. The present disclosure is directed towards a practical application of path planning and mapping algorithms to cause a robot to change from a first path to a different second path upon detection or receipt of a rerouting zone which encompasses, at least in part, the first path. In some implementations, a robot may globally reroute, which may allow the robot to move to other navigable areas in order to navigate around an area that through which it cannot navigate and/or navigation would be undesirable.

Exemplary embodiments described herein have innovative features, no single one of which is indispensable or solely responsible for their desirable attributes. Without limiting the scope of the claims, some of the advantageous features will now be summarized.

According to inventive concepts disclosed herein, systems, non-transitory computer readable medium, and methods are directed to navigating a robotic device, comprising, at least, maneuvering the robotic device along a trajectory following a first route; receiving one or more rerouting zones on a computer readable map of an environment, the one or more rerouting zones corresponding to a region in the environment that the robotic device does not navigate; changing the trajectory of the robotic device from the first route to a different second route based on the location of the one or more rerouting zones, the second route comprising portions of the first route; and maneuvering the robotic device along the second route such that the robotic device avoids the one or more rerouting zones. Further, the systems, non-transitory computer readable medium, and methods include, inter alia, determining the one or more rerouting zones based on either sensor data or input received from a user or network; removing portions of the first route within the one or more rerouting zones; and performing optimizations on first and second points of the first route to determine the second route such that the second route comprises no discontinuities or unnavigable segments, the second route being of minimal length required to navigate the robotic device along remaining portions of the first route such that the remaining portions of the first route correspond to the second route.

Moreover, the systems, non-transitory computer readable medium, and methods may further include, removing segments of the remaining portions of the first route based on the segments falling below a length threshold; determining the second route based on directional requirements to be followed by the robotic device, the directional requirements including a direction for the robotic device while navigating the first and second routes; and determining the second route based on a combination of portions of the first route and a portion of a third route that is outside of the one or more rerouting zones.

The inventive concepts disclosed are performed by features in specific and particular configuration that make non-abstract improvements to computer technology and functionality. Some of these improvements in computer technology and functionality include executing specialized algorithm by unique and specialized processor(s) that allow the processor to perform faster and more efficiently than conventional processor(s); and requires usage of less memory space as data is collected, analyzed and stored therein. Accordingly, the inventive concepts disclosed herein are an improvement over the conventional technology or prior art directed to maneuvering a robot along a trajectory that are prone to safety risks to itself, humans and objects around it. Lastly, structural components disclosed herein, such as, for example, various sensor units, navigation units, actuator units, communication units and user interface units, are oriented in a specific manner and configuration that is unique to the functioning and operation of the robotic device as it maneuvers along a path.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with the embodiments of the present disclosure.

FIG. 1B is a functional block diagram of a controller or processor in accordance with example embodiments of the present disclosure.

FIG. 2 illustrates a functional block diagram of a network in accordance with the example embodiments of the present disclosure.

FIG. 3 is a process flow diagram illustrating a method for rerouting a path of a robot according to an exemplary embodiment.

FIG. 4A is a top view rendering of a computer readable map comprising a route to be followed by a robot according to an exemplary embodiment.

FIG. 4B is a top view rendering of a computer readable map illustrating the removal of portions of a route due to a rerouting zone and the determination of optimizations to the remaining portions of the route according to an exemplary embodiment.

FIG. 4C is a top view rendering of a computer readable map illustrating the determination of a new route based on the rerouting zone and optimizations determined in FIG. 4B, according to an exemplary embodiment.

FIG. 5A illustrates a top view rendering of a computer readable map illustrating a plurality of routes within an environment according to an exemplary embodiment.

FIG. 5B illustrates the implementation of a rerouting zone to the computer readable map illustrated in FIG. 5A, according to an exemplary embodiment.

FIG. 5C illustrates a plurality of rerouted routes due to the implementation of a rerouting zone according to an exemplary embodiment.

FIG. 6A illustrates a rendering of a computer readable map of an environment comprising a robot and a plurality of routes to navigate according to an exemplary embodiment.

FIG. 6B illustrates a robot navigating a plurality of rerouting zones imposed on the computer readable map illustrated previously in FIG. 6A, according to an exemplary embodiment.

FIG. 6C illustrates a robot navigating a plurality of directional requirements and rerouting zones imposed on the computer readable map previously illustrated in FIG. 6A-B, according to an exemplary embodiment.

FIG. 7A-B illustrate a robot detecting a rerouting zone along its path and changing the path to avoid the rerouting zone, according to an exemplary embodiment.

All Figures disclosed herein are © Copyright 2021 Brain Corporation. All rights reserved.

### DETAILED DESCRIPTION

Various aspects of the novel systems, apparatuses, and methods disclosed herein are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting the scope of the disclosure being defined by the appended claims and equivalents thereof.

Some exemplary embodiments of the present disclosure relate to robots, such as robotic mobile platforms. As used herein, a robot may include mechanical and/or virtual entities configured to carry out a series of actions automatically. In some embodiments, robots may be machines that are guided and/or instructed by computer programs and/or electronic circuitry. In some embodiments, robots may include electromechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAYS®, wheelchairs, etc.), stocking machines, trailer movers, vehicles, and the like. Robots may also include any autonomous and/or semi-autonomous machine for transporting items, people, animals, cargo, freight, objects, luggage, and/or anything desirable from one location to another. In some embodiments, such robots used for transportation may include robotic mobile platforms as the robots are mobile systems that may navigate and/or move autonomously and/or semi-autonomously. These robotic mobile platforms may include autonomous and/or semi-autonomous wheelchairs, bikes, row boats, scooters, forklifts, trams, trains, carts, vehicles, tugs, and/or any machine used for transportation.

As referred to herein, floor cleaners may include floor cleaners that are manually controlled (e.g., driven or remote controlled) and/or autonomous (e.g., using little to no direct user control). For example, floor cleaners may include floor scrubbers that a janitor, custodian, or other person operates and/or robotic floor scrubbers that autonomously navigate and/or clean an environment. Similarly, floor cleaners may also include vacuums, steamers, buffers, mops, polishers, sweepers, burnishers, etc.

Certain examples are described herein with reference to floor cleaners or mobile platforms, or robotic floor cleaners or robotic mobile platforms. Such examples are used for illustration only, and the principles described herein may be readily applied to robots generally.

In some embodiments, robots may include appliances, machines, and/or equipment automated to perform one or more tasks. For example, a module may be attached to the appliances, machines, and/or equipment to allow them to operate autonomously. Such attaching may be done by an end user and/or as part of the manufacturing process. In some embodiments, the module may include a motor that drives the autonomous motions of the appliances, machines, and/or equipment. In some cases, the module causes the appliances, machines, and/or equipment to operate based at least in part on spoofing, such as by sending control signals to pre-existing controllers, actuators, units, and/or components of the appliances, machines, and/or equipment. The module may include sensors and/or processors to receive and generate data. The module may also include processors, actuators, and/or any of the components described herein to process the sensor data, send control signals, and/or otherwise control pre-existing controllers, units, and/or components of the appliances, machines, and/or equipment. Such appliances, machines, and/or equipment may include cars, floor cleaners, rovers, drones, planes, boats, carts, trams, wheelchairs, industrial equipment, stocking machines, mobile platforms, personal transportation devices, stocking machines, trailer movers, vehicles, and/or any type of machine.

Detailed descriptions of the various implementations and embodiments of the system and methods of the present disclosure are now provided. While many examples discussed herein may refer to robotic floor cleaners, it will be appreciated that the described systems and methods contained herein are applicable to any kind of robot. Myriad other example implementations or uses for the technology described herein would be readily envisaged by those having ordinary skill in the art, given the contents of the present disclosure.

Advantageously, the systems and methods of the present disclosure may at least: (i) allow robots to operate in complex environments; (ii) allow robots to operate in dynamic environments; (iii) provide for more natural movements of a robot that may better resemble how a human would handle a task; (iv) provide for computationally efficient management of robot resources; (v) minimize disruptions to robotic tasks; (vi) improve the efficiency and/or effectiveness of robots; and (vii) allow robots to navigate and perform tasks while avoiding obstacles. Other advantages are readily discernable by one having ordinary skill in the art given the contents of the present disclosure.

For example, in some embodiments, a robot may travel along one or more predetermined path. The robot may be configured to make adjustments to the predetermined path and/or paths to avoid obstacles, such as people, items, animals, blockades, fences, machines, displays, robots, fixtures, and/or other things in the way. These obstacles may be temporary or permanent. In some embodiments, these adjustments may allow the robot to navigate around the obstacles with only slight deviation from the predetermined path and/or paths. For example, when encountering an obstacle, the robot may make a slight turn left or right and go around the obstacle. After the robot has cleared the obstacle, the robot may return to the predefined path and/or paths. In some cases, a robot may also wait for obstacles to be cleared (e.g., moved by a machine or person, and/or the obstacle itself moves away). The robot may stop and wait until the obstacle is cleared, and then continue on the predefined path and/or paths.

However, in some instances, a robot may not be able to navigate around an obstacle. For example, the obstacle may sufficiently block the robot, or the traveled path of the robot, so that the robot cannot fit around the obstacle and/or the robot cannot navigate around the obstacle in a desirable way (e.g., without going to an area undesirable for the robot to travel and/or crashing into something else). As another example, there may be a plurality of obstacles, wherein going around a first obstacle could present a robot with more obstacles, which in some cases, may cause the robot to get stuck. In some cases, the obstacle may not be cleared and/or the robot may not have sufficient time to wait for the obstacle to be cleared out of its traveled path. Advantageously, systems and methods of this disclosure may allow a robot to continue performing a robotic task even when faced with obstacles that substantially impede the robots progress along a predefined path and/or paths.

By way of illustration, in some embodiments, the robot may comprise a floor cleaner. The floor cleaner may perform the task of cleaning a floor. In some embodiments, the robot may combine navigation (e.g., movement from one location to another) with the task of cleaning (e.g., using water, rotating brushes, vacuuming, buffing, polishing, articulating, and/or any other cleaning related action). Accordingly, the robot may clean a portion of a floor area. In some embodiments, there may be some portions that an operator desires to clean and some areas in which an operator does not desire to clean. For example, the floor cleaner may be a hard floor scrubber. An operator would desire for the hard floor scrubber to clean hard surfaces (e.g., tile, concrete, terrazzo, ceramic, and/or other hard surfaces), but not soft surfaces (e.g., carpet, artificial grass or turf, mats, and/or other soft surfaces). The robot may be configured to clean along a predetermined path and/or paths in an environment, wherein the path and/or paths may provide at least a sequence of areas to which a robot travels.

In some embodiments, the robot may operate in an environment, such as a warehouse, store, office building, and/or any space cleaning is desirable. In some embodiments, such an environment may be dynamic with aisle closures, materials placed on floors, forklifts and/or other machinery, customers/workers and/or other people, spills, inventory and/or storage, and/or other items that may cover floors. In some cases, these dynamic elements may form obstacles that may impede the travel of the robot as the robot cleans. Moreover, in such environments, the robot may have predetermined areas to clean in a given session. Accordingly, the impediments to travel may prevent the robot from completing the job or the desired, pre-programmed task.

Advantageously, systems and methods described in this disclosure may allow the robot to bypass an area that the robot may not be able to navigate and go to other areas in which it is desirable for the robot to perform tasks. This may allow a robot to efficiently perform a robotic task (e.g., cleaning), especially if the task is to be completed in a desired amount of time. In some cases, this may allow a robot to complete other portions. The robot may be configured to later go back and perform a task in the area that the robot skipped.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, LTE/LTE-A/TD-LTE/TD-LTE, GSM, etc.), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computer (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, specialized processors (e.g., neuromorphic processors), and application-specific integrated circuits (“ASICs”). Such digital processors may be contained on a single unitary integrated circuit die or distributed across multiple components.

As used herein, computer program and/or software may include any sequence or human or machine cognizable steps, which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

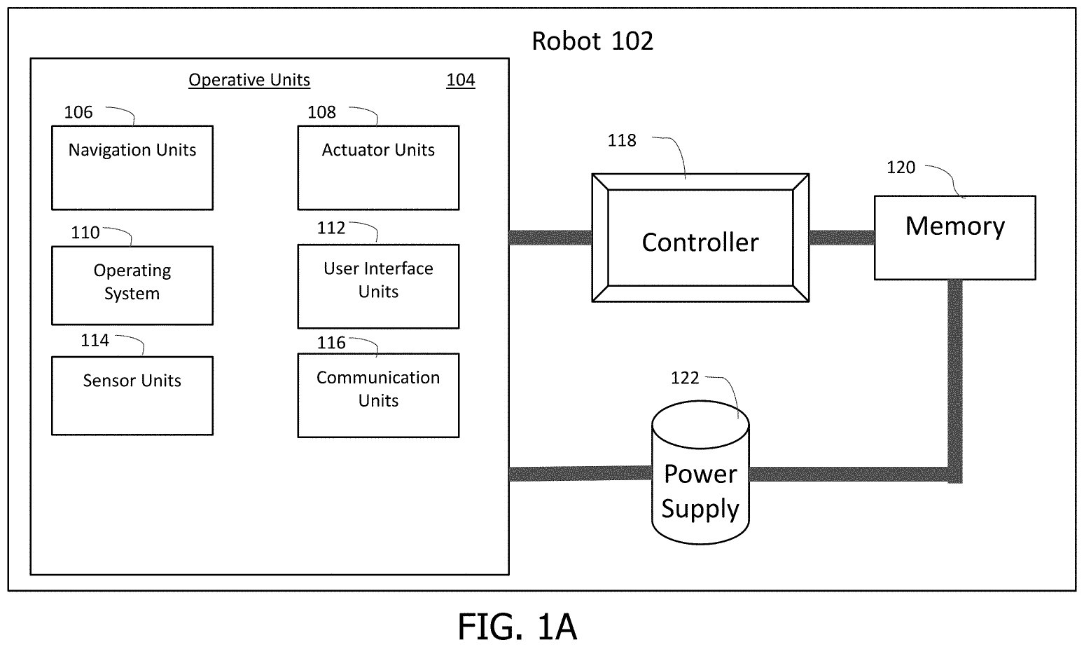

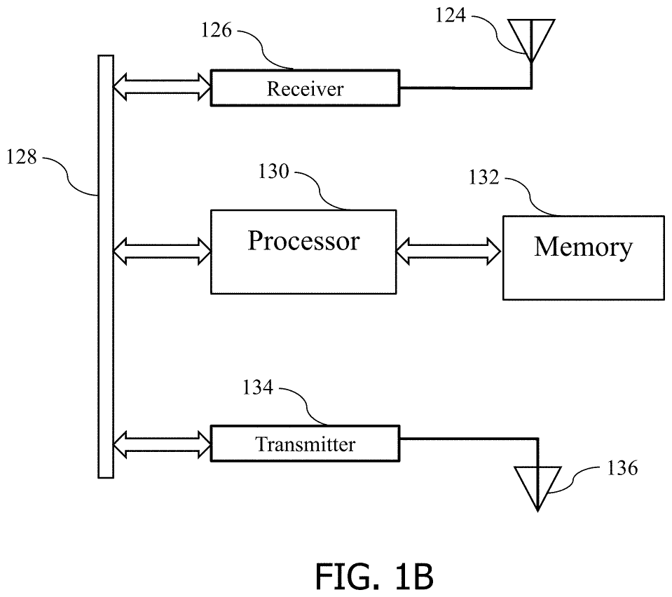

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors (e.g., microprocessors) and other peripherals. As previously mentioned and used herein, processor, microprocessor, and/or digital processor may include any type of digital processing device such as, without limitation, digital signal processors (“DSPs”), reduced instruction set computers (“RISC”), complex instruction set computer (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, specialized processors (e.g., neuromorphic processors), and application-specific integrated circuits (“ASICs”). Such digital processors may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), nonvolatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processor may be external to robot 102 and be communicatively coupled to controller 118 of robot 102 utilizing communication units 116 wherein the external processor may receive data from robot 102, process the data, and transmit computer-readable instructions back to controller 118. In at least one non-limiting exemplary embodiment, the processor may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processors. In some embodiments, a single controller (e.g., controller 118) may serve as the various controllers and/or processors described. In other embodiments different controllers and/or processors may be used, such as controllers and/or processors used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units that provide the various functionality of robot 102. In exemplary embodiments, operative units 104 may be instantiated in software, hardware, or both software and hardware. For example, in some cases, units of operative units 104 may comprise computer-implemented instructions executed by a controller. In exemplary embodiments, units of operative unit 104 may comprise hardcoded logic. In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; rotate cameras and sensors.

Actuator unit 108 may include any system used for actuating, in some cases to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LIDAR”) sensors, radars, lasers, cameras (including video cameras (e.g., red-blue-green (“RBG”) cameras, infrared cameras, three-dimensional (“3D”) cameras, thermal cameras, etc.), time of flight (“TOF”) cameras, structured light cameras, antennas, motion detectors, microphones, and/or any other sensor known in the art. According to exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on measurements. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include the position of robot 102 (e.g., where position may include a location of the robot, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long-term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

According to exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

According to exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used here on out, a robot 102, a controller 118, or any other controller, processor, or robot performing a task illustrated in the figures below comprises a controller executing computer readable instructions stored on a non-transitory computer readable storage apparatus, such as memory 120, as would be appreciated by one skilled in the art.

Next referring to FIG. 1B, the architecture of the specialized controller 118 used in the system shown in FIG. 1A is illustrated according to an exemplary embodiment. As illustrated in FIG. 1B, the specialized controller 118 may further include a data bus 128, a receiver 126, a transmitter 134, at least one processor 130, and a memory 132. The receiver 126, the processor 130 and the transmitter 134 all communicate with each other via the data bus 128. The processor 130 may be a specialized processor configured to execute specialized algorithms. The processor 130 may be configured to access the memory 132, which stores computer code or instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configured to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing by the specialized controller 118. The receiver 126 communicates these received signals to the processor 130 via the data bus 128. As one skilled in the art would appreciate, the data bus 128 is the means of communication between the different components—receiver, processor, and transmitter—in the specialized controller 118. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code, algorithm, or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configured to further communicate the output signals to a plurality of operative units 104 illustrated by signal output 136.

One of ordinary skill in the art would appreciate that the architecture illustrated in FIG. 1B may illustrate an external server architecture configured to effectuate the control of a robotic apparatus from a remote location. That is, the server may also include a data bus, a receiver, a transmitter, a processor, and a memory that stores specialized computer readable instructions thereon.

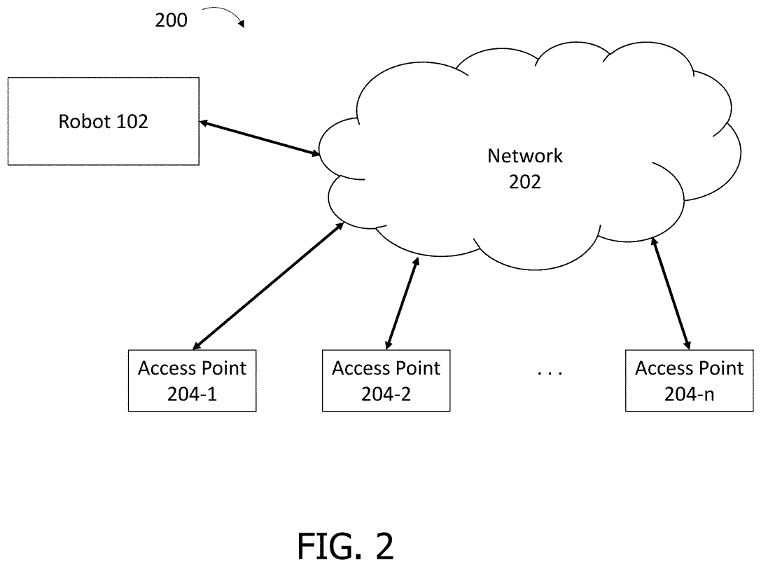

According to at least one non-limiting exemplary embodiment, robot 102 may be communicatively coupled to a network. FIG. 2 is a functional block diagram of system 200, which includes robot 102 communicatively and/or operatively coupled to network 202 in accordance with some embodiments of this disclosure. Network 202 may comprise a collection of hardware, software, services, and/or resources that may be invoked to instantiate a virtual machine, process, or other resource for a limited or defined duration, or an unlimited or undefined duration. Network 202 may be communicatively and/or operatively coupled to a plurality of devices, systems, and/or servers, including devices and/or servers that have access to the internet. One or more of access points, such as access points 204-1 and 204-2, may be devices, systems, and/or servers, including, but not limited to, computers, mobile devices, tablets, smart phones, cells phones, personal digital assistants, phablets, e-readers, smart watches, set-top boxes, internet streaming devices, gaming consoles, smart appliances, and/or any device with access to the internet and/or any network protocol. Network 202 may be communicatively coupled to “n” access points, wherein index “n” may be any positive integer number greater than one that corresponds to the number of access points connected.

Network 202 may have onboard computers that may receive, process, and/or send information. These computers may operate autonomously and/or under control by one or more human operators. Similarly, network 202 may have access points (e.g., access points 204-1, 204-2, etc.), which may similarly be used to operate network 202. The access points may have computers and/or human operators that may receive, process, and/or send information. Accordingly, references herein to operation of network 202 may be applied to a human operator and/or a computer operator.

According to at least one non-limiting exemplary embodiment, multiple robots 102 (e.g., of a same or different types of robot) may be communicatively and/or operatively coupled to network 202. Each of these robots may communicate statuses, commands, and/or operative data to network 202. Network 202 may also store and/or communicate statuses, commands, and/or operative data to these robots. In some cases, network 202 may store maps, sensor data, and other information from robot 102 and/or other robots. Network 202 may then share experiences of a plurality of connected robots to each other. Moreover, with the aggregation of information, network 202 may perform machine learning algorithms to improve performance of the robots.

A person having ordinary skill in the art would appreciate from the contents of this disclosure that some portions of this disclosure may be performed by robot 102, network 202, and/or access points 204-n. Though certain examples may be described with reference to one or more of robot 102, network 202, and/or access points 204-n, it would be appreciated that the features of the examples may be distributed amongst robot 102, network 202, and/or access points 204-1 and/or 204-2 to achieve substantially similar results.

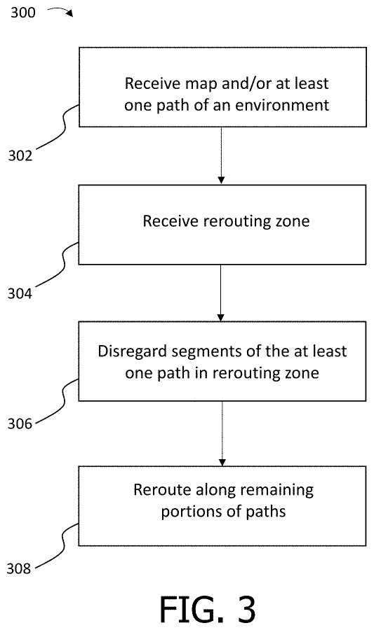

FIG. 3 is a process flow diagram of an exemplary method 300 for a robot 102 to reroute a path in accordance with some implementations of this disclosure. It is appreciated that any steps of method 300 performed by a robot 102 further comprises of a controller 118 of the robot 102 executing computer readable instructions stored on memory 120 to operate one or more operative units 104 depicted in FIG. 1A above, as appreciated by one skilled in the art.

Block 302 includes receiving a map and/or at least one path of an environment. For example, the map and/or at least one path of the environment may be used by the robot to navigate the environment. By way of illustration, a map may be indicative at least in part of features of an environment. The map may include the locations, orientations, poses, etc. of features in the environment, such as relative to a mobile or a stationary reference. For example, such features may include one or more shelves, machines, items, displays, cubicles, offices, windows, glass, doors, fixtures, appliances, robots, people, and/or any other thing that is in the environment and properties thereof detectable using sensor units 114 (e.g., color, contours, material composition, etc.). According to some non-limiting exemplary embodiments, the environment may be static (e.g., things in the environment are not moving and/or do not change position), dynamic (e g, things in the environment move and/or change position), or static in some areas and dynamic in others. According to at least one non-limiting exemplary embodiment, the map may indicate the features of an environment at a particular time. According to another non-limiting exemplary embodiment, the map may indicate the features of an environment at a plurality of times, combining information from a plurality of maps, which indicate features of the environment at a particular time.

A path may include a route in which the robot travels in the environment. For example, a path may include a plurality of locations to which a robot travels. The plurality of locations may form a sequence, wherein the robot travels to the locations in the sequence in a particular order such that the robot follows a preconfigured course through an environment. According to at least one non-limiting exemplary embodiment, a path may be learned by a robot, such as through demonstration and/or other learning processes. According to another non-limiting exemplary embodiment, a path may be uploaded onto a robot, such as through a map, coordinates, images, and/or other data forms from an external server (e.g., network 202) or device (e.g., access points 204-n, user interface units 112, etc.). According to at least one non-limiting exemplary embodiment, a path may include a route between two points spatially separated within an environment of a robot 102, wherein controller 118 of the robot 102 may determine a route between the two points for the robot 102 to follow using, at least in part, the systems and methods of the present disclosure to modify its route between the two points away from rerouting zones while, for example, minimizing distance traveled by the robot 102.

According to at least one non-limiting exemplary embodiment, a map and at least one path may be combined into a data structure or may be stored using separate data structures. A data structure may include a matrix, array, and/or any other data structure. The data structure may be of two-, three-, or more dimensions wherein portions of the data structure correlate to locations (e.g., relative and/or absolute) in an environment. For example, in a two-dimensional (“2D”) data structure, each pixel may correlate at least in part to a physical location in the environment in which the robot navigates. Similarly, in a three-dimensional (“3D”) data structure, each voxel may correlate at least in part to a physical location in the environment in which the robot navigates. A 2D data structure may be used where the robot operates in substantially planar operations (e.g., where the movements of robot 200, whether on a level surface or otherwise, operate within a plane, such as left, right, forward, back, and/or combinations thereof), whereas a 3D data structure may be used where robot 200 operates in more than planar operations, such as up, down, row, pitch, and/or yaw in addition to left, right, forward, and back. Where a space has more characteristics associated with locations (e.g., temperature, time, complexity, etc.), there may be more dimensions to the data structure. According to at least one non-limiting exemplary embodiment, the map may comprise various regions (e.g., pixels of the map) with an associated cost thereto (i.e., a cost map), wherein regions representing objects on the map comprise a higher cost relative to regions comprising no objects or obstructions to the robot 102 path thereby encouraging the robot 102 to avoid objects or obstacles by executing a path or route comprising a lowest cost of all potential routes the robot 102 may take.

Block 304 includes receiving a rerouting zone. The rerouting zone may be inputted by an operator and/or user via user interface units 112 of a robot 102 or access points 204-n of a network 202 commutatively coupled to the robot 102. In some embodiments, a rerouting zone may be detected by a sensor units 114 of the robot 102 or a separate robot 102 (e.g., also coupled to network 202), wherein the rerouting zone may be communicated to the robot 102 via respective communication units 116. The rerouting zone may be indicative at least in part of an area in which it is undesirable for the robot 102 to traverse. For example, the rerouting zone may be an area where the robot 102 may get stuck in navigation (e.g., has limited maneuverability that may cause the robot 102 to have difficulty in moving around and/or in/out of the rerouting zone), it is undesirable for the robot 102 to travel (e.g., an area where robotic navigation would be disruptive), is at least partially blocked off, and/or any other reason. In this example, the robot 102 may superimpose its footprint (i.e., area occupied by the robot 102), or a similar representation, object, representation, correspondence, or instance, onto the map received in block 302 to determine if collisions with objects is avoidable by manipulating its path and, upon detecting no paths through a region avoid collision with objects therein, determine the region to comprise a rerouting zone.

The rerouting zone may comprise a region (e.g., a bounded region, pixels on a computer readable map, region of high cost, etc.) encompassing at least in part the path received in block 302 which may be difficult or impossible for the robot 102 to navigate through. In some embodiments, a rerouting zone may be detected based on a presence of one or more objects within the rerouting zone, the presence being detected using sensor units 114. In some embodiments, the controller 118 may execute path planning algorithms to determine a route for the robot 102 to follow without colliding with objects, wherein a rerouting zone may be detected if no possible routes exist without collision with objects within the rerouting zone.

According to at least one non-limiting exemplary embodiment, the map received in block 304 may comprise of a cost map. A cost threshold may be imposed for a route for the robot 102 to follow, wherein the robot 102 may only execute routes or paths comprising an associated cost, which is below the cost threshold. Accordingly, a rerouting zone may be detected if no paths through the zone may be determined to comprise a cost below the cost threshold. One skilled in the art would appreciate the cost map may be an implementation of sensor data taken from operative units 104 and builds, or represents, the same in a two-dimensional or three-dimensional occupancy grid.

Block 306 includes disregarding segments of the at least one path in the rerouting zone received in block 304. The robot 102 may have one or more segments of the at least one paths that would lead the robot 102 through the rerouting zone if the robot 102 followed those one or more segments. Such one or more segments may be identified, such as by (a) an operator selecting the one or more segments on a map, or (b) the robot 102 automatically identifying the one or more segments. By way of illustrative non-limiting examples, a robot 102 which automatically identifies the one or more segments may determine an aisle, corridor, and/or other structure is blocked, such as by detecting at least one obstacle or other impedance. The determination of the blockages by the robot 102 may be based at least in part on how much of the aisle, corridor, and/or other structure is blocked, such as a percentage; the ability of the robot 102 to go around the at least one obstacle; the number of obstacles, the location of the obstacles (e.g., at the mouth or width of an aisle), the type of obstacle detected (e.g., gate, cone, etc.), an indicator of a rerouting zone (e.g., a symbol or other machine readable information that may indicate to the robot 102 a rerouting zone). The robot 102 may then identify that aisle, corridor, and/or other structure as a rerouting zone, thereby disregarding the one or more segments through that rerouting zone.

Block 308 includes the robot 102 rerouting along remaining portions of paths. During rerouting, the robot 102 may disregard remaining portions of the at least one path that do not meet a minimum length threshold, wherein the minimum length threshold may be a predetermined threshold set by a user or a controller of a robot and may determine the minimum length requirement for a remaining portion of paths to be considered during rerouting. In addition, the robot 102 may also disregard portions of the at least one path that do not meet a minimum turn angle rotation of the robot 102, wherein the minimum turn angle rotation may be a predetermined threshold set by a user or a controller of a robot, and may determine the minimum turn angle of rotation requirement for the remaining portion of paths to be considered during rerouting. After excluding one or more segments of the at least one path which pass through the rerouting zone, the robot 102 may then determine a rerouting path to, for example, perform tasks in areas outside the rerouting zone that it should otherwise perform in those areas. Such performance may include the robot 102 navigating to areas in the map where the robot 102 would have travelled despite the rerouting zone.

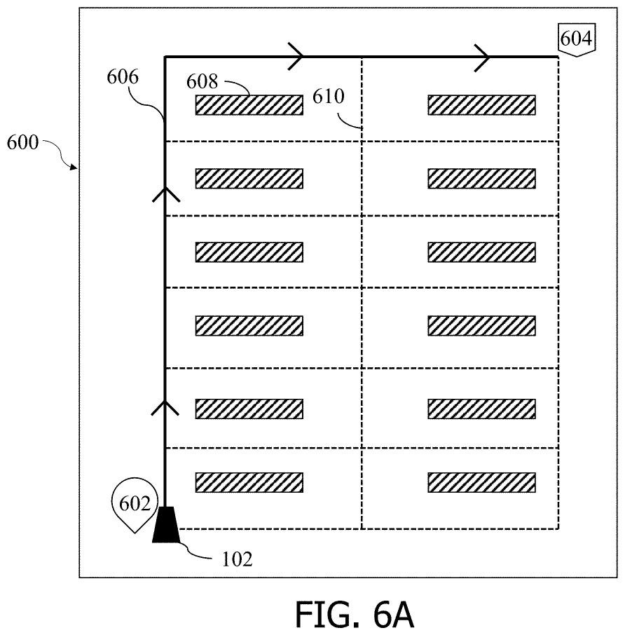

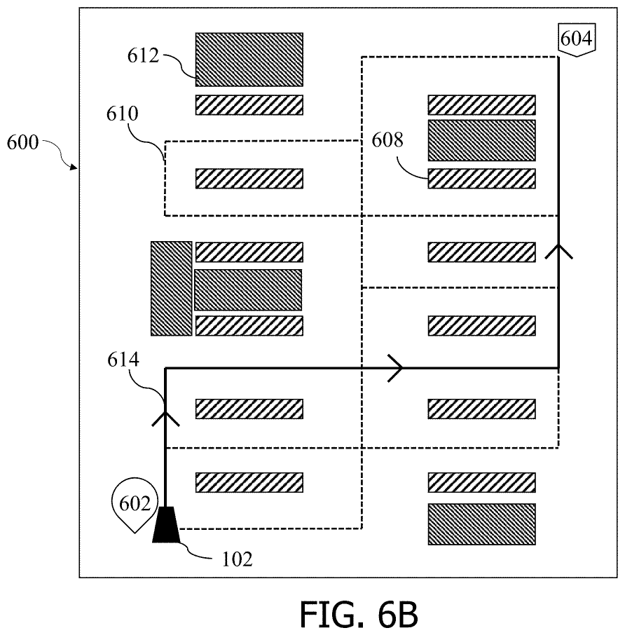

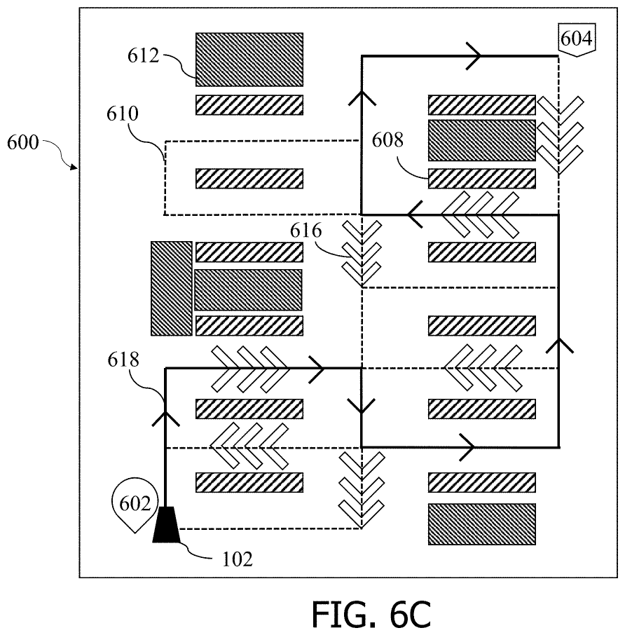

According to at least one non-limiting exemplary embodiment, performing such tasks may not depend on the direction of travel of the robot 102. For example, where the robot is a floor cleaner, it may only matter to operators that the robot 102 travels over areas on the floor, but it does not matter what direction the robot 102 travels over the floor. However, according to another non-limiting exemplary embodiment, the direction of travel may matter for a task, thus there may be additional parameters to consider or limitations on the rerouting path, further illustrated below in FIG. 6C.

According to at least one non-limiting exemplary embodiment, the rerouting path may include a route for travelling. For example, the route may include translation of a robot 102 from a first location to a second location. The route may include a plurality of positions, orientations, and/or poses of the robot 102, such as a plurality of positions, orientations, and/or poses associated with locations in an environment. The route may include a linear path, where the robot 102 travels directly from a first location to a second location, or may be a more complex path, including winding, double-backing, overlapping, u-turning, and/or other maneuvering in an environment as the robot translates. Such maneuvering may allow the robot 102 to complete a task. For example, the robot 102 may be a floor cleaner wherein the maneuvering may allow the robot 102 to clean areas of a floor. As another example, where the robot 102 is transporting items, people, animals, cargo, freight, objects, luggage, and/or anything desirable from one location to another, such maneuvering may allow the robot 102 to go to different locations for pick-up, drop-off, site seeing, avoiding obstacles, and/or any other reason.

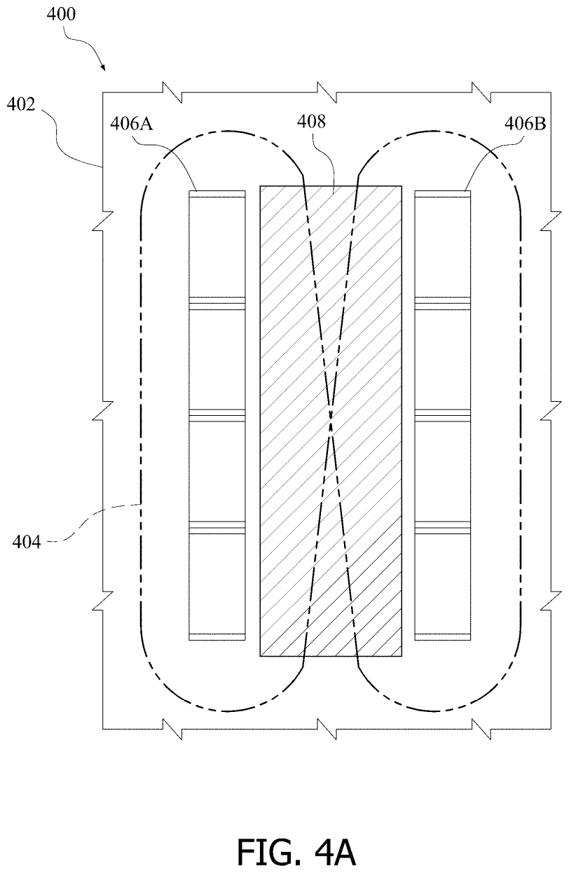

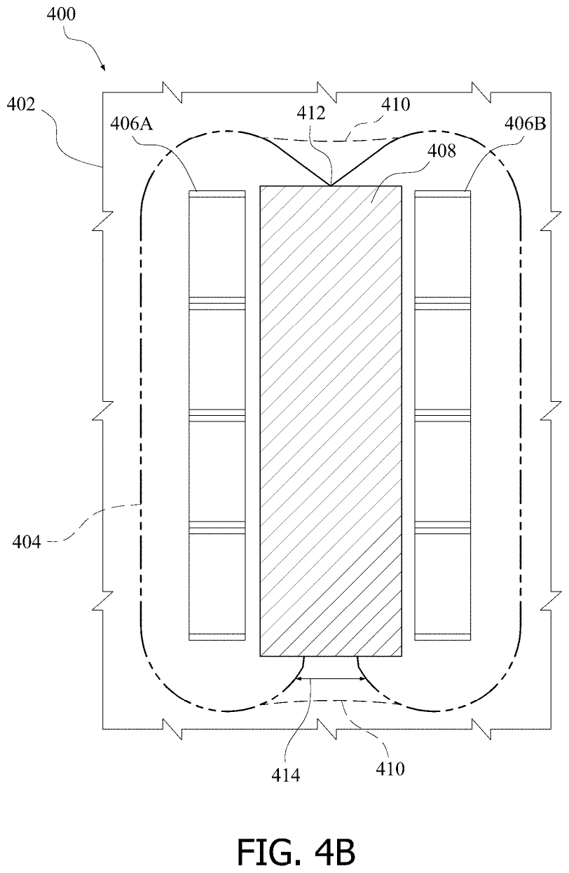

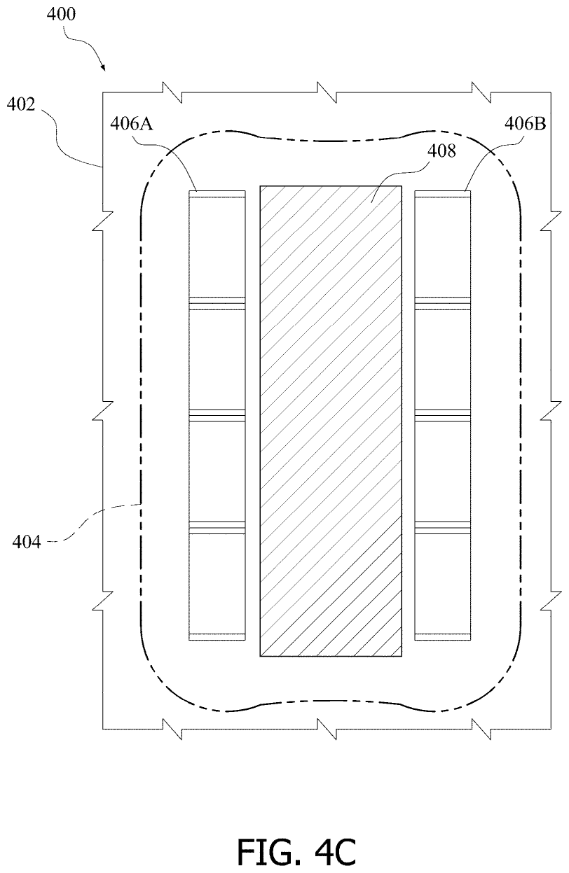

FIG. 4A illustrates a top view of a rendering of a computer readable map 400 comprising a route 404 according to an exemplary embodiment. Icon 402 of map 400 may be representative, at least in part, of a reference location such as a home location, initialization location, reference position/item, and/or any other position on map 400. Obstacles 406A and 406B correspond to mapped obstacles within map 400 and may be, for example, shelves, walls, and/or other obstacles, which may restrict the movements of a robot 102. Rerouting zone 408 may be a zone determined to be undesirable for the robot 102 to travel. Rerouting zone 408 may be determined, for example, by a robot 102 detecting obstacles between barriers 406A and 406B, which may impede the ability of the robot 102 to travel within rerouting zone 408. According to at least one non-limiting exemplary embodiment, rerouting zone 408 may be determined by a human giving input to an access point 204, as previously illustrated in FIG. 2; a human providing input to a user interface unit 112 on the robot 102; or other robots detecting obstacles between barriers 406A and 406B, determining the zone to be rerouting zone 408, and communicating the location of rerouting zone 408 to a network 202. As illustrated, portions of route 404 lie within rerouting zone 408 requiring those portions of route 404 to be rerouted to avoid navigation into rerouting zone 408.

FIG. 4B illustrates the removal of the portions of route 404 which lie within rerouting zone 408, previously illustrated in FIG. 4A, to determine a new route for a robot 102 to follow such that the robot 102 avoids navigating into rerouting zone 408, according to an exemplary embodiment. As illustrated in FIG. 4B, upon removing the portions of route 404 within rerouting zone 408 the remaining portions of route 404 may comprise one or more unnavigable sharp turn 412, comprising a turn unnavigable by the robot 102 due to, for example, physical constraints of the robot 102 (i.e., minimum turning radius or minimum length of the robot 102), or gap 414, comprising a discontinuity in the route 404. The gap 414 is present due to removal of a portion of the route 404 within the rerouting zone 408 causing the remaining portions of route 404 to become discontinuous. Accordingly, the robot 102 may, in real-time as it follows its desired trajectory or travels along a path, calculate optimizations 410 to the remaining route 404 to account for the unnavigable sharp turn 412 and gap 414 caused by the removal of the portions of route 404 that lie within rerouting zone 408. Optimizations 410 may be calculated by a controller 118 of the robot 102 using specialized algorithms stored in a memory 120 to compute optimizations 410 such that route 404 comprises no gap 414, unnavigable sharp turn 412, and minimizes the length of new rerouted path 416, illustrated below in FIG. 4C. These specialized algorithms may include, but are not limited to, path length minimization optimization algorithms such as, for example, Euclidean distance measurements, traveling salesman algorithms, or similar algorithms and may be further utilized in conjunction with additional route smoothing optimization algorithms configured to ensure no sharp turns 412 arise due to the path length minimization algorithms. Such route optimization to take into account of unnavigable sharp turn 412, and avoiding gap 414, may be done so in real-time as the robot 102 is traveling a desired trajectory along a path.

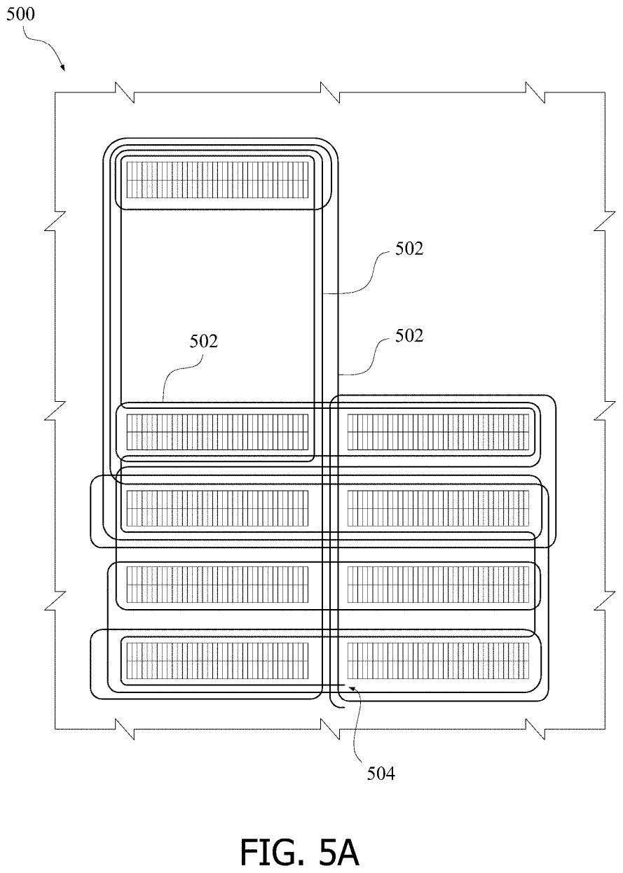

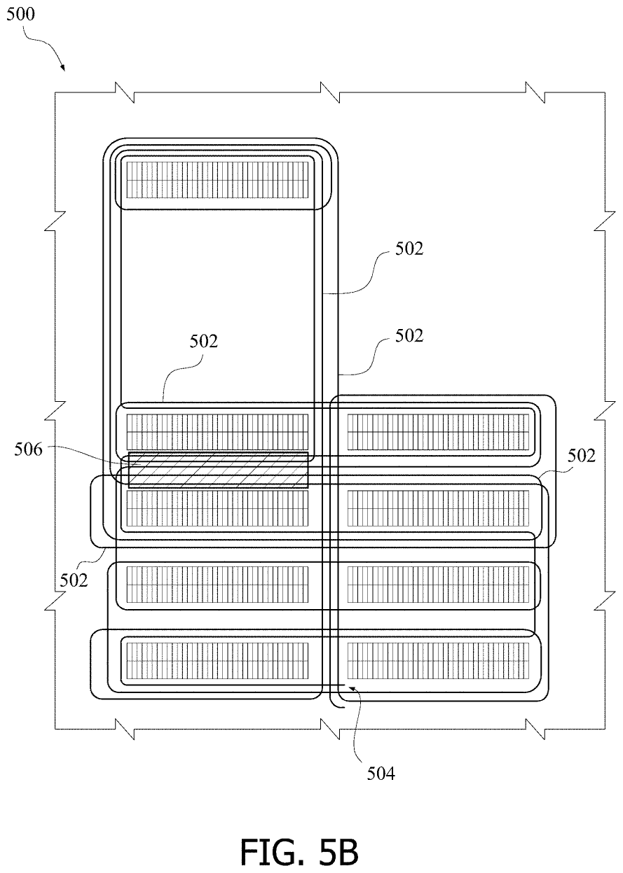

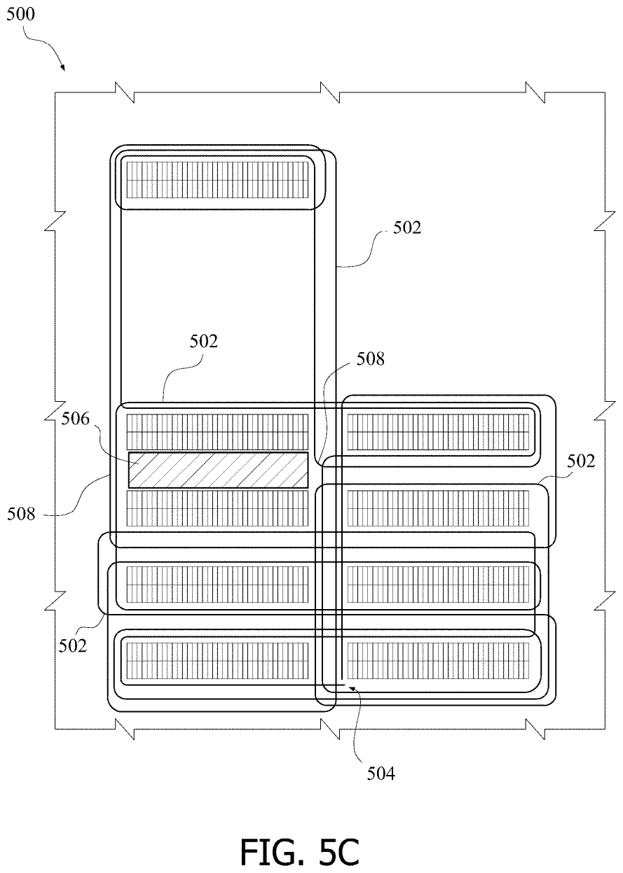

According to at least one non-limiting exemplary embodiment, a controller calculating optimizations 410 may consider additional parameters such as, including, but not limited to, surrounding obstacles, other rerouting zones, physical parameters of the robot (e.g., turn radius, size, etc.), and/or tasks to perform along route 404 requiring the robot to be oriented in a specific direction. In the exemplary embodiment where the robot is required to be oriented in a specific direction along route 404, optimizations 410 may comprise adding substantial additional route length, which may cause the robot to navigate to a separate location to orientate itself properly, wherein optimization 410 may still minimize the additional route length to accomplish this. According to at least one non-limiting exemplary embodiment, optimizations 410 may comprise the use of segments or connecting of segments of other nearby routes known to a robot 102, as further illustrated below in FIG. 5A-C.

FIG. 4C illustrates a rerouted path 416, comprising a rerouted route 404 with optimizations 410 implemented as illustrated previously in FIG. 4A-B thereby generating the new rerouted path 416, according to an exemplary embodiment. As illustrated, the new rerouted path 416 does not maneuver a robot 102 into rerouting zone 408, thereby avoiding the rerouting zone 408. Rerouted path 416 may comprise a substantially similar path to route 404, shown in FIGS. 4A-B, in areas outside of rerouting zone 408 and not affected (e.g., removed, added, or changed) by optimizations 410, shown in FIG. 4B.

According to at least one non-limiting exemplary embodiment, a robot 102 may be required to navigate a route or portion of a route along a certain direction requiring further parameters to consider when determining rerouted path 416, as further illustrated below in FIG. 6C.

FIG. 5A illustrates a top view of a rendering of a computer readable map 500 of an environment comprising a plurality of routes 502 according to an exemplary embodiment. The plurality of routes may be utilized by one or more robots to accomplish one or more tasks by following routes 502. The routes 502 may be similarly illustrative of a single long route through of the map 500. Map 500 may additionally include icon 504 indicative of, for example, a start location, home location, known feature/landmark, and/or other distinguishable feature or location.

FIG. 5B illustrates a rerouting zone 506 imposed on the map 500 of an environment according to an exemplary embodiment. Rerouting zone 506 may be communicated to a robot 102 through, for example, a network 202, a user interface 112 on the robot 102, and/or determined by the robot 102 upon observing obstacles within rerouting zone 506. As illustrated in FIG. 5B, the route travelled by the robot 102 includes a no-go zone that requires the robot 102 to reroute around. This no-go zone or the rerouting zone 506 is indicative of path not to be traveled by the robot 102.

FIG. 5C illustrates a plurality of rerouted routes 508 within a map 500 of an environment comprising a rerouting zone 506 according to an exemplary embodiment. Rerouted routes 508 may be determined by removing segments of routes 502 within or surrounding the rerouting zone 506, and performing optimizations to the routes 502 with the removed segments, as illustrated above in FIG. 4A-B. Additionally, a plurality of routes 502 may be unchanged after imposing the rerouting zone 506 as the plurality of unchanged routes 502 may not comprise route segments within the rerouting zone 506.

Additionally, the rerouted routes 508 may be determined by combining portions or segments of one or more previously traveled routes 502, previously illustrated in FIG. 5A-B, such that a robot 102 navigating along the combined routes (e.g., rerouted routes 508) may still navigate to areas outside of rerouting zone 506. The combination of routes may be performed where two routes intersect or are of close proximity, thereby requiring minimum optimizations to connect a gap between the two routes. A robot may combine two or more segments of routes 502 to determine one or more rerouted routes 508 to accomplish a set of tasks while avoiding rerouting zone 506. In other words, a robot 102 navigating a route of routes 502 may utilize a portion of another route of routes 502 to avoid rerouting zone 506, thereby creating a rerouted route 508. The rerouted route 508 being a new route or different route than previously traveled route 502 as the rerouted route 508, which avoids the rerouting zone 506. According to at least one non-limiting exemplary embodiment, a robot 102 may combine segments of routes 502 such that the robot may navigate along a specified direction at specified locations, as further illustrated below in FIG. 6A-C.

FIG. 6A illustrates a rendering of a computer readable map 600 of an environment comprising a plurality of obstacles 608 and a robot 102 desiring to navigate along route 606 from a start point 602 to an end point 604 according to an exemplary embodiment. Map 600 may further comprise a plurality of route segments 610, illustrated by dashed lines, to be combined by the robot 102 to generate a route 606, or other routes, from the start point 602 to the end point 604. As illustrated, a plurality of possible routes from start point 602 to end point 604 may be determined by combining the route segments 610, where route 606 is just one of the plurality of possible routes for a robot 102 to choose from.

FIG. 6B illustrates a robot 102 determining a rerouted path 614 from the start point 602 to the end point 604, based on the remaining route segments 610 after imposing a plurality of rerouting zones 612, according to an exemplary embodiment. That is, by implementing a plurality of rerouting zones 612 on the map 600, a plurality of route segments 610 on the map 600 may be removed, as it may not be desirable for a robot to navigate those segments 610 that fall or lie within the rerouting zones 612. For example, map 600 may be a map of a supermarket, or warehouse, comprising a plurality of aisles between obstacles 608. A robot 102 may determine a plurality of rerouting zones 612 based on obstacles such as shopping carts within the aisles, people within the aisles, and/or other reasons for avoiding rerouting zones 612. The remaining route segments 610 may be combined to determine a rerouted path 614 from the start point 602 to the end point 604 for the robot 102 to follow. The robot 102 may determine a plurality of possible paths comprising a combination of different route segments 610 to reach the end point 604, however, many of these routes may not be the shortest path from the start point 602 to the end point 604. Accordingly, the robot 102 may determine in real-time a route 614 to be the most optimal route, comprising the shortest distance from the start point 602 to the end point 604. A plurality of other routes from the start point 602 to the end point 604 may comprise the same length as route 614, wherein the robot 102 may decide to use route 614 based on other parameters such as accomplishing tasks along the route (e.g., cleaning specific aisles along route 614), orientating along a correct direction along the route and at the end point 604, avoiding obstacles not indicated by rerouting zones 612, and/or a plurality of other parameters.

According to at least one non-limiting exemplary embodiment, route segments 610 may comprise segments of other routes (not shown in their entirety) used by the robot 102 or other robots (not shown) to accomplish tasks within the environment of map 600, wherein the robot 102 may combine these route segments 610 to determine a rerouted path 614 upon receiving one or more rerouting zones 612. The other routes comprising the plurality of route segments 610 may lie on top or within close proximity to each other, as similarly illustrated above in FIG. 5A-C, and may be combined to generate a route 606 or 614, or other route, from the start point 602 to the end point 604.

According to at least one non-limiting exemplary embodiment, a robot 102 may be required to make optimizations to route 614 upon combining various segments 610 to determine the route 614 such as, for example, in situations where a discontinuity or sharp turn, as illustrated above in FIG. 4B, is determined upon combining segments 610. That is, in order to determine the optimal route 614 for robot 102 to travel, factors such as discontinuity 414, sharp turn 412, length of the robot 102, rotation angle of the robot 102, are taken into account.

According to at least one non-limiting exemplary embodiment, a robot 102 may make changes to a rerouted path 614 during navigation of the rerouted path 614 upon receiving or determining a new rerouting zone 612 during navigation. One skilled in the art would appreciate that new rerouting zones 612 may be identified on map 600 in real-time by user-input or other mechanisms disclosed herein. And accordingly, rerouting of the traveled path of the robot 102 in order to avoid the newly identified rerouted path 614 may also be achieved and accomplished in real-time.

FIG. 6C illustrates a computer readable map 600 of an environment comprising a plurality of rerouting zones 612, obstacles 608, and route segments 610 previously illustrated in FIG. 6B, and a plurality of directional requirements 616, illustrated by triple arrows along some route segments 610, according to an exemplary embodiment. The directional requirements 616 may be implemented, for example, to cause the robot 102 to navigate safely (e.g., navigating along the direction of foot traffic within a store) or to accomplish a task requiring the robot to navigate in a specific direction. The directional requirements may be imposed on map 600 and may be communicated to the robot 102 by a user interface unit 112 of the robot 102 or via a network 202 coupled to the robot 102 to cause the robot 102 to navigate along the direction of the directional requirements 616. Accordingly, upon imposing the directional requirements 616, route 614 or portions of route 614 may be required to be rerouted along route 618 (as indicated by bolded line). Route 618 may be determined based on both the rerouting zones 612 and the directional requirements 616 and may comprise the shortest distance from the start point 602 to the end point 604 while following the restrictions set forth by the rerouting zones 612 and the directional requirements 616.

According to at least one non-limiting exemplary embodiment, a robot 102 desiring to navigate from a start point 602 to an end point 604 may not determine a possible route due to restrictions set forth by imposed rerouting zones 612 and directional requirements 616. Accordingly, the robot 102 may communicate this to a network 202 or a human operator causing the network 202 or human operator to determine one or more rerouting zones 612 to be unnecessary, determine one or more directional requirements 616 to be unnecessary, or to determine the robot 102 should halt until one or more rerouting zones 612 or directional requirements 616 imposed are removed and a possible path may be determined.

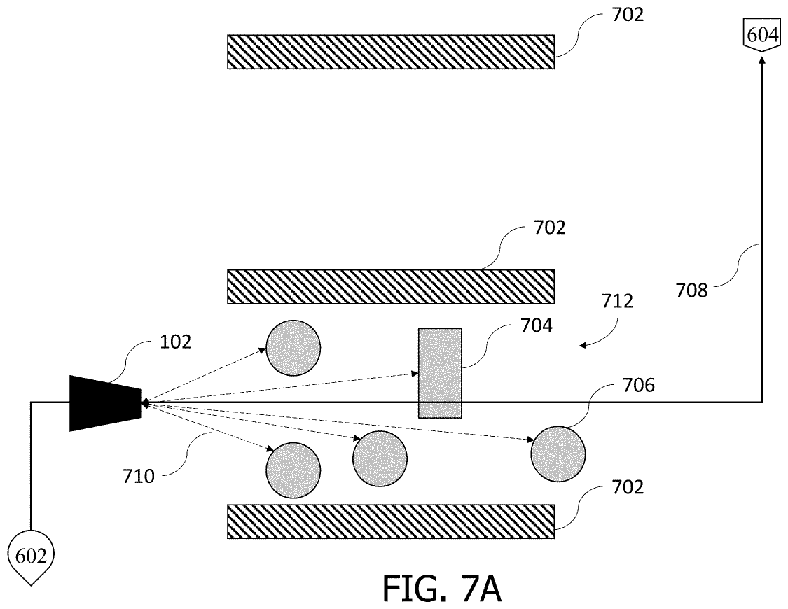

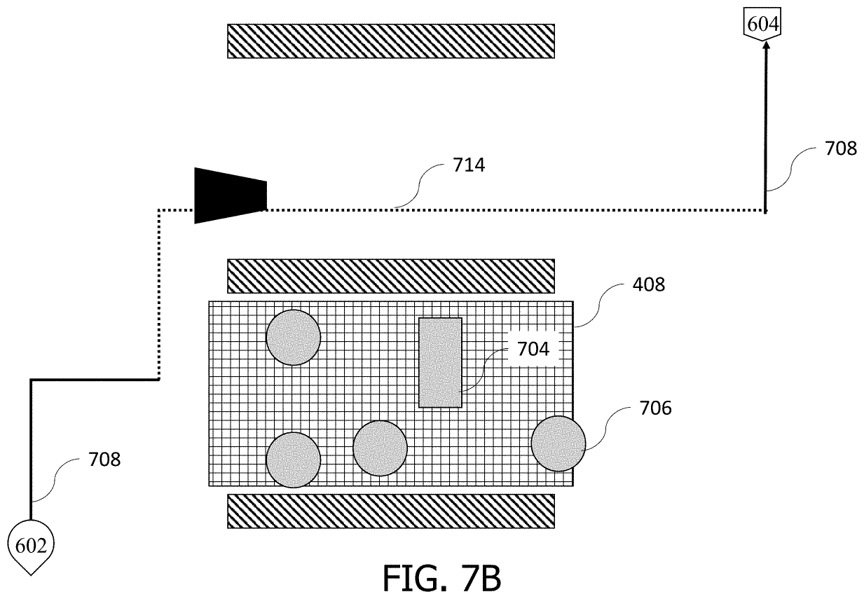

FIG. 7A illustrates a robot 102 navigating between a start point 602 to an end point 604 through an environment illustrated by a computer readable map 700 to illustrate a method of detecting a rerouting zone 408, according to an exemplary embodiment. A controller 118 of the robot 102 may receive the map 700 of the environment from, e.g., network 202 or using sensor unit 114 data collected during prior navigation through the environment. Path 708 may comprise of a shortest distance path for the robot 102 to follow between the start point 602 and end point 604, wherein the controller 118 may activate one or more actuator units 108 to effectuate navigation of the robot 102 along the path 708. Upon navigating a portion of path 708, however, sensor units 114 of the robot 102 may detect a plurality of objects 704, 706 obstructing navigation of the path 708. For example, environment 700 may comprise of a supermarket, wherein objects 704, 706 may represents shopping carts and people browsing the items on shelves 702 (i.e., static and/or dynamic objects). As illustrated, continued navigation along route 708 may cause collision between the robot 102 and objects 704, 706.

According to at least one non-limiting exemplary embodiment, controller 118 may verify that continued navigation along route 708 through region 712 may cause a collision by superimposing a footprint of the robot 102, or area occupied by the robot 102 as illustrated, onto the computer readable map 700 and simulate navigation along the route 708 (i.e., project the footprint further along the route 708 than the physical location of robot 102). If overlap between the footprint and objects 704 and/or 706 is detected on the map during simulated navigation of route 708, or similar routes through the same region 712 (i.e., region occupied by objects 704, 706), then a potential collision may be detected. If there is no potential path through region 712, which avoids collision, the region 712 may be determined to be a rerouting zone 408.

According to at least one non-limiting exemplary embodiment, map 700 may be representative of a cost map. Region 712 may be determined to comprise a rerouting zone 408 if all paths through region 712 comprise an associated cost exceeding a threshold value, as discussed above.

Next, in FIG. 7B, a rerouting zone 404 (checkered region) may be imposed onto the computer readable map 700 in real-time. With reference to FIG. 7A, a portion of route 708 is encompassed within the rerouting zone 408. Accordingly, a controller 118 of the robot 102 may execute method 300 (i.e., blocks 306-308) to determine a new route 714 for the robot 102 to follow. The new route 714 may comprise a substantial portion of the original route 708 as illustrated; however, this is not intended to be limiting. The new route 714, comprising a modification to portions of the first route 708 to avoid navigation through a detected rerouting zone 408, may comprise some or no portions of the original route 708 based on, e.g., locations of objects 702, 704, 706, and others; locations of start point 602 and end point 604; and/or tasks for the robot 102 to perform as robot 102 navigates to the end point 604 (e.g., cleaning floors). The new route 714 may further comprise of a shortest route between the start point 602 and end point 604 which avoids the rerouting zone 408.

According to at least one non-limiting exemplary embodiment, the new route 714 may comprise of a lowest cost route between the start point 602 and end point 604 if map 700 is a cost map, as described above.

According to at least one non-limiting exemplary embodiment, the rerouting zone 408 detected by the robot 102 may be communicated to a network 202 such that other robots 102 (e.g., of a same or different type, functionality, etc.) within the environment may consider the rerouting zone 408 during planning of their respective routes.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, un-recited elements or method steps; the term “having” should be interpreted as “having at least;” the term “such as” should be interpreted as “such as, without limitation;” the term “includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A method for navigating a robotic device, comprising:
maneuvering the robotic device along a trajectory following a first route;
receiving one or more rerouting zones on a computer readable map of an environment, the one or more rerouting zones corresponding to a region in the environment that the robotic device does not navigate;
changing the trajectory of the robotic device from the first route to a different second route based on the location of the one or more rerouting zones, the second route comprising portions of the first route; and
maneuvering the robotic device along the second route such that the robotic device avoids the one or more rerouting zones.

2. The method of claim 1, further comprising:
determining the one or more rerouting zones based on either sensor data or input received from a user or network.

3. The method of claim 1, further comprising:
removing portions of the first route within the one or more rerouting zones; and
performing optimizations on first and second points of the first route to determine the second route such that the second route comprises no discontinuities or unnavigable segments, the second route being of minimal length required to navigate the robotic device along remaining portions of the first route such that the remaining portions of the first route correspond to the second route.

4. The method of claim 3, further comprising:
removing segments of the remaining portions of the first route based on the segments falling below a length threshold.

5. The method of claim 3, further comprising:
determining the second route based on directional requirements to be followed by the robotic device, the directional requirements including a direction for the robotic device while navigating the first and second routes.

6. The method of claim 3, further comprising:
determining the second route based on a combination of portions of the first route and a portion of a third route that is outside of the one or more rerouting zones.

7. A robotic system, comprising:
a non-transitory computer readable medium having computer readable instructions stored thereon;
at least one controller configured to execute the computer readable instructions to:
maneuver the robotic system along a trajectory following a first route;
receive one or more rerouting zones on a computer readable map of an environment, the one or more rerouting zones corresponding to a region in the environment that the robotic system does not navigate; and
change the trajectory of the robotic system from the first route to a different second route based on the location of the one or more rerouting zones, the second route comprising portions of the first route; and
maneuvering of the robotic system along the second route such that the robotic system avoids the one or more rerouting zones.

8. The robotic system of claim 7, wherein the at least one controller is further configured to execute the computer readable instructions to,
determine the one or more rerouting zones based on sensor data or input received from a user or network.

9. The robotic system of claim 7, wherein the at least one controller is further configured to execute the computer readable instructions to,
remove portions of the first route within the one or more rerouting zones; and
perform optimizations on first and second points of the first route to determine the second route such that the second route comprises no discontinuities or unnavigable segments, the second route being of minimal length required to navigate the robotic system along remaining portions of the first route such that the remaining portions of the first route correspond to the second route.

10. The robotic system of claim 9, wherein the at least one controller is further configured to execute the computer readable instructions to,
remove segments of the remaining portions of the first route based on the segments falling below a length threshold.

11. The robotic system of claim 9, wherein the at least one controller is further configured to execute the computer readable instructions to,
determine the second route based on directional requirements to be followed by the robotic system, the directional requirements including a direction for the robotic system while navigating the first and second routes.

12. The robotic system of claim 9, wherein the at least one controller is further configured to execute the computer readable instructions to,
determine the second route based on a combination of portions of the first route and a portion of a third route outside of the one or more rerouting zones.

13. A non-transitory computer readable storage medium comprising a plurality of computer readable instructions stored thereon, that when executed by a controller, configure the controller to:
maneuver a robotic system along a trajectory following a first route;
receive one or more rerouting zones on a computer readable map of an environment, the one or more rerouting zones corresponding to a region in the environment that the robotic system does not enter;
change the trajectory of the robotic system from the first route to a different second route based on the location of the one or more rerouting zones, the second route comprising portions of the first route; and
maneuver the robotic system along the second route such that the robotic system avoids the one or more rerouting zones.

14. The non-transitory computer readable storage medium of claim 13, wherein the controller is further configured to execute plurality of instructions to,
determine the one or more rerouting zones based on sensor data or input received from a user or network.

15. The non-transitory computer readable storage medium of claim 13, wherein the controller is further configured to execute plurality of instructions to,
remove portions of the first route within the one or more rerouting zones; and
perform optimizations on the first and second points of the first route to determine the second route such that the second route comprises no discontinuities or unnavigable segments, the second route being of minimal length required to navigate the robotic system along remaining portions of the first route such that the remaining portions of the first route correspond to the second route.

16. The non-transitory computer readable storage medium of claim 15, wherein the controller is further configured to execute plurality of instructions to,
remove segments of the remaining portions of the first route based on the segments falling below a length threshold.

17. The non-transitory computer readable storage medium of claim 15, wherein the controller is further configured to execute plurality of instructions to,
determine the second route based on directional requirements to be followed by the robotic system, the directional requirements including a direction for the robotic system while navigating the first and second routes.

18. The non-transitory computer readable storage medium of claim 15, wherein the controller is further configured to execute plurality of instructions to,
determine the second route based on a combination of portions of the first route and a portion of a third route that is outside of the one or more rerouting zones.
